(19) United States
(12) Patent Application Publication
(10) Pub. No.: US 2012/0316977 A1
(43) Pub. Date: Dec. 13, 2012

(54) COMMODITY SALES DATA PROCESSING APPARATUS AND CONTROL METHOD THEREOF

(75) Inventor: Yasuyuki Suzuki, Kanagawa-ken (JP)

(73) Assignee: TOSHIBA TEC KABUSHIKI KAISHA, Tokyo (JP)

(21) Appl. No.: 13/486,271

(22) Filed: Jun. 1, 2012

(30) Foreign Application Priority Data
Jun. 7, 2011 (JP) 2011-127659
Feb. 27, 2012 (JP) 2012-039821

(51) Int. Cl. G06Q 20/20

(52) U.S. Cl. 705/21; 705/16

(57) ABSTRACT

A commodity sales data processing apparatus receives input of a comprehension degree which indicates the comprehension degree of a customer purchasing the commodity whose explanation is required by a salesperson if the sales data of the commodity whose explained is required by the salesperson is input through an input unit, and stores an information indicating the comprehension degree received in association with an identification information of at least one of the commodity and the salesperson.

### CROSS-REFERENCE TO RELATED APPLICATIONS

The present application is based upon and claims the benefit of priorities from Japanese Patent Application No. 2011-127659 filed on Jun. 7, 2011 and Japanese Patent Application No. 2012-039821 filed on Feb. 27, 2012, the entire contents of which are hereby incorporated by reference.

### FIELD

Embodiments described herein relate to a commodity sales data processing apparatus for a retail store, which handles commodities with explanations thereof when selling the commodities, such as medicines, and a control method thereof.

### BACKGROUND

In the commodities sold in a store, for some commodities, salespersons are required to explain usage thereof and the like to customers purchasing the commodities.

### BRIEF DESCRIPTION OF THE DRAWINGS

FIG. 1 is a skeleton diagram of a POS system of one embodiment;

FIG. 2 is a view showing the data record format of a commodity master file managed by a file server of the POS system shown in FIG. 1;

FIG. 3 is a view showing the data record format of a salesperson master file managed by the file server;

FIG. 4 is a view showing the data record format of an explanation analysis data file managed by the file server;

FIG. 5 is a view showing an example of a comprehension degree input screen displayed by a POS terminal of the POS system;

FIG. 6 is a block diagram illustrating a main unit composition of the POS terminal;

FIG. 7 is a view showing an example of the key configuration of a keyboard with which the POS terminal is equipped;

FIG. 8 is a view showing a main memory area formed in a RAM of the POS terminal;

FIG. 9 is a flow chart showing procedures executed by a CPU of the POS terminal according to a control program; and

FIG. 10 is a view showing an example of a comprehension degree analysis report for each salesperson issued from the POS terminal.

### DETAILED DESCRIPTION

According to one embodiment, a commodity sales data processing apparatus includes a comprehension degree receiving section and a comprehension degree storing section. The comprehension degree receiving section configured to receive input of degree of a comprehension of a customer purchasing the commodity whose explanation is required by a salesperson if the sales data of the commodity whose explanation is required by the salesperson is input. The comprehension degree storing section configured to store an information indicating the comprehension degree received by the comprehension degree receiving section in association with an identification information of at least one of the commodity and the salesperson.

Hereinafter, an embodiment of a commodity sales data processing apparatus is described with reference to the accompanying drawings.

The present embodiment is a case in which function as the commodity sales data processing apparatus is applied to a POS terminal of a POS (Point Of Sales) system constructed in a retail store, such as convenience store, supermarket and the like, which sells medicines.

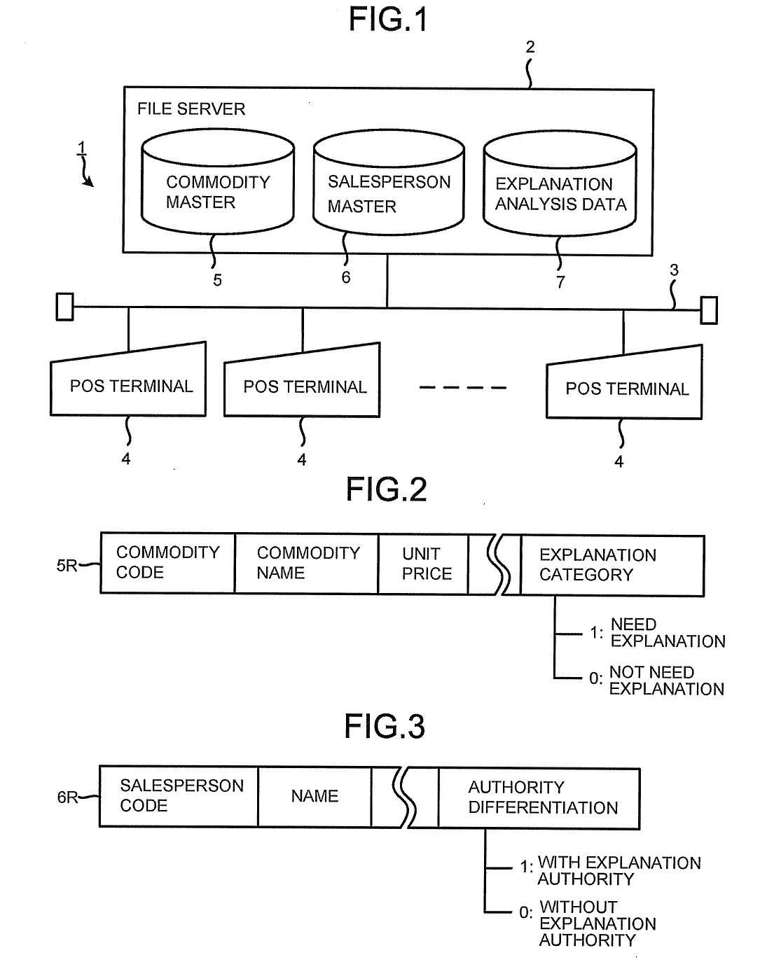

FIG. 1 is a skeleton diagram of the POS system 1 according to the embodiment. The POS system 1 comprises a file server 2 and a plurality of POS terminals 4 which are connected with the server 2 through a network 3 such as a LAN (Local Area Network) and the like. The file server 2 stores and manages various data files such as a commodity master file 5, a salesperson master file 6, an explanation analysis data file 7 and the like.

The commodity master file 5 stores data records 5R relevant with the commodities sold in a shop. As shown in FIG. 2, besides including the commodity inherent information such as commodity code, commodity name, unit price and the like, the data records 5R of the commodities further include item of explanation category. The explanation category is used for identifying whether or not commodities specified by the corresponding commodity codes are medicines needing the explanation thereof by a salesperson. In the embodiment, the differentiation of the medicines needing the explanation thereof is set to be 1, and the differentiation of the commodities not needing the explanation thereof except the medicines is set to be 0.

The salesperson master file 6 stores data records 6R relevant with salesclerks in charge of the sell of the commodities, namely salespersons. As shown in FIG. 3, besides including the salesperson inherent information such as salesperson code, salesperson name and the like, the salesperson data records 6R further include item of the category of authority. The category of authority is used for identifying whether or not the salespersons specified by the corresponding salesperson codes are pharmacists or registered salesclerks with explanation authority when selling the medicines. In the embodiment, the differentiation of the salespersons having the explanation authority is set to be 1, and the differentiation of the salespersons not having the explanation authority is set to be 0.

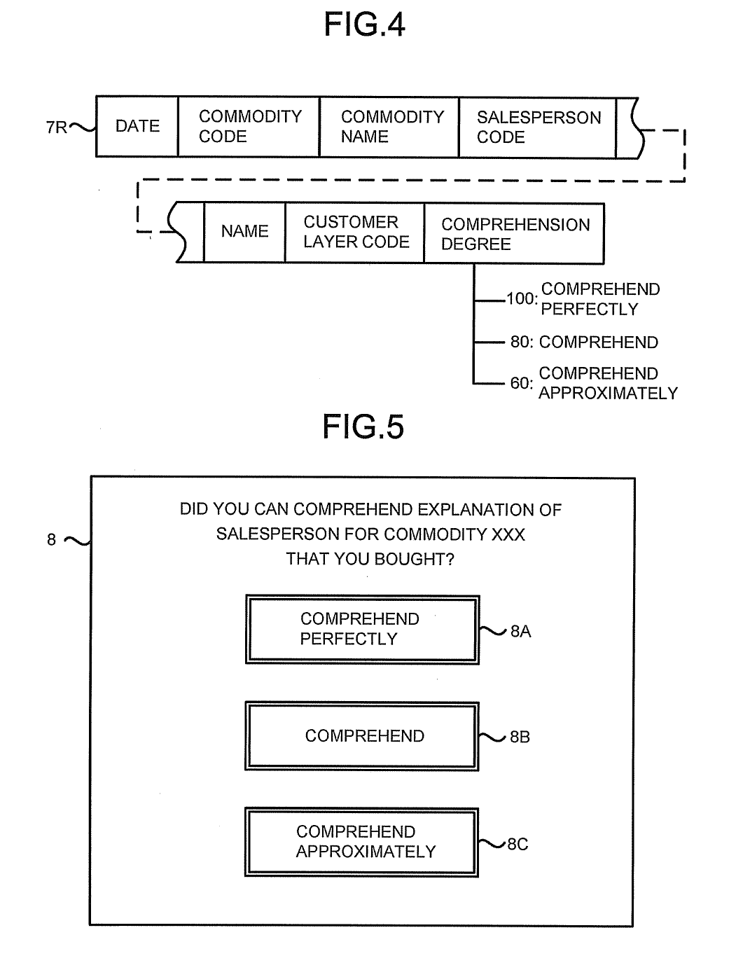

The explanation analysis data file 7 stores the sales data records 7R of the commodities explained by the salespersons when selling the commodities. As shown in FIG. 4, besides including the actual sales achievement data such as, commodity code, commodity name, salesperson code, salesperson name and the like, the explanation analysis data records 7R further include items of customer layer code and comprehension degree information.

The customer layer codes are used for identifying gender and age group of the customers who respectively receive explanations of purchased commodities specified by the corresponding commodity codes from the salespersons specified by the corresponding salesperson codes at corresponding dates. In the embodiment, the age group is divided into five stages at which males and females are respectively divided into “less than 20s”, “30s”, “40s”, “50s” and “more than 60s”.

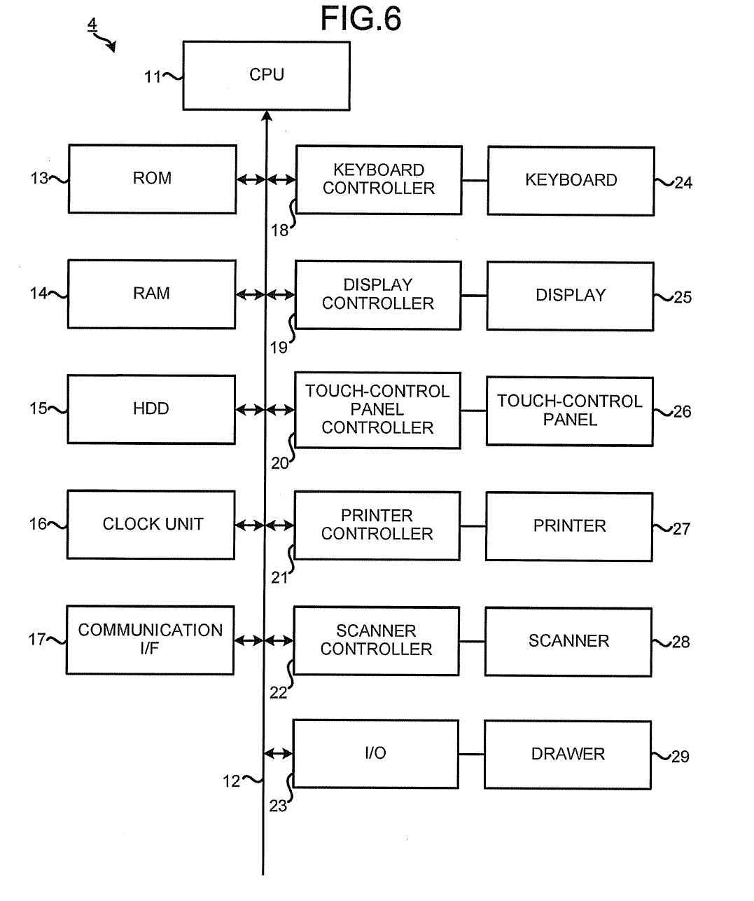

The comprehension degree information shows comprehension degree of the customer who receives the explanation of the commodity by the salesperson, and in the embodiment, the comprehension degree is divided into three stages of “fully understand”, “understand” and “approximately understand”. Moreover, the comprehension degree information is digitized, for example, the “fully understand” is set to be 100, the “understand” is set to be 80, and the “approximately understand” is set to be 60. The comprehension degree is input from a comprehension degree input screen 8 shown in FIG. 5. The comprehension degree input screen 8 is displayed on a touch panel 26 (referring to FIG. 6) of the POS terminal 4, and the comprehension degree input screen 8 is provided with buttons for respectively showing the comprehension degree, namely a “fully understand” button 8A, an “understand” button 8B and an “approximately understand” button 8C. Moreover, the customer who receives the explanation by the salesperson touches one of the buttons according to own understanding of the explanation to input her or his comprehension degree.

FIG. 6 is a block diagram illustrating main unit compositions of the POS terminal 4. The POS terminal 4 carries a CPU (Central Processing Unit) 11 as a control unit body. Moreover, the CPU 11 is connected, through bus-lines including an address bus, a data bus and the like, with a ROM (Read Only Memory) 13 and a RAM (Random Access Memory) 14 as main memory units, an HDD (Hard Disk Drive) 15 as an auxiliary memory unit, a clock unit 16 for timing current date and time and a communication interface 17 for performing a data communication through the network 3. In addition, the POS terminal 4 connects all units of a keyboard controller 18, a display controller 19, a touch panel controller 20, a printer controller 21, a scanner controller 22 and an I/O port 23 through the buses 12.

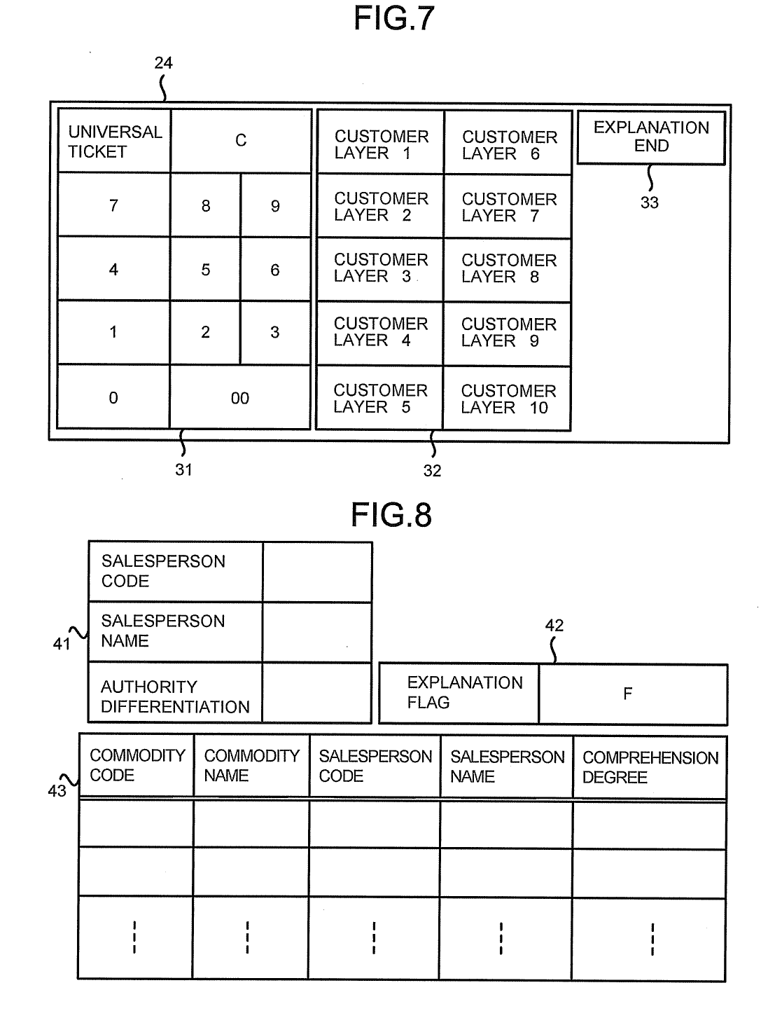

The keyboard controller 18 acquires a key signal corresponding to an operated key from a keyboard 24. As shown in FIG. 7, besides being equipped with number keys 31 (00 and 0 to 9), ten (10) customer layer keys 32 which are respectively assigned to customer layers corresponding to the age group of the five (5) stages according to the genders, the keyboard 24 is further equipped with an explanation end key 33. The explanation end key 33 functions as a declaration means for declaring the end of the explanation by the salesperson about the commodity to be purchased.

The display controller 19 controls the screen display of a display 25. Commodity names, unit prices, sales numbers and sales amount of the commodities purchased by the customer, sum of sales amount, change amount and the like are displayed on the display 25.

The touch panel controller 20 controls the screen display of the touch panel 26 and acquires a coordinate data signal representing a touch position. The comprehension degree input screen 8 is displayed on the touch panel 26. Moreover, in the condition that the coordinate data signal representing the touch position in the area of the “fully understand” button 8A of the screen 8 is input from the touch panel 26, the touch panel controller 20 determines that the input comprehension degree is the “fully understand”. Similarly, in the case that the coordinate data signal representing the touch position in the area of the “understand” button 8B is input from the touch panel 26, the touch panel controller determines that the input comprehension degree is the “understand”, and in the case that the coordinate data signal representing the touch position in the area of the “approximately understand” button 8C is input from the touch panel 26, the touch panel controller determines that the input comprehension degree is the “approximately understand”. The touch panel controller 20 then notifies the CPU 11 of data showing the determined comprehension degree.

The printer controller 21 controls a printer 27 for printing a receipt. The scanner controller 22 controls a scanner 28 for reading a bar-code such as the commodity codes, the salesperson codes and the like. The I/O port 23 outputs to a drawer 29 a drive signal for opening the drawer 29.

In order to analyze the comprehension degrees of the customers about the explanations of the salespersons to the customers purchasing the medicines, the constructed POS terminal 4 described above arranges memory areas 41, 42 and 43 as shown in FIG. 8 on the RAM 14. The memory area 41 stores salesperson information including the codes, the names and the categories of authority of the salespersons. If the salesperson information with the category of authority “1” is registered in the memory area 41, the commodities which are necessary to be explained by the salespersons, namely the medicines can be sold by the registered salesperson. An explanation flag F which is set to be 1 if the salesperson explains the commodities (medicines) is stored in the memory area 42. Corresponding to each commodity (medicine) explained by the salesperson, the memory area 43 stores the commodity code, the commodity name, the salesperson code and the name of the salesperson carrying out the explanation and the numerical value information representing the comprehension degree of the customer as a one record.

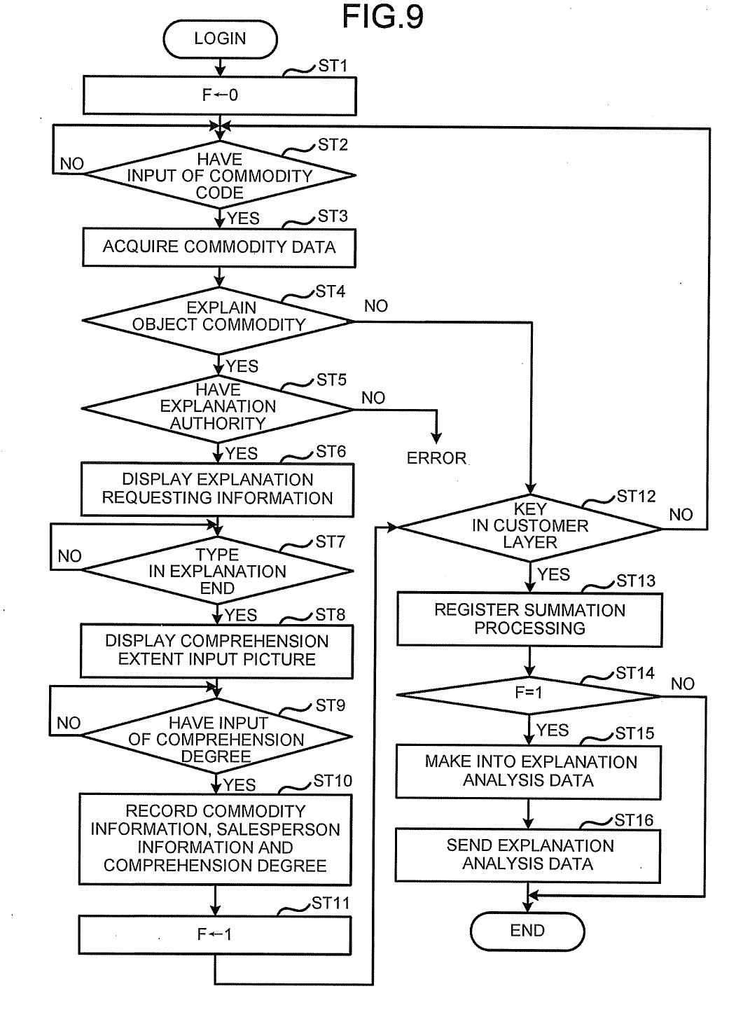

The POS terminal 4 stores a control program in the ROM 13 which is used by the CPU 11 to execute processes shown in the flow chart of FIG. 9. The control program is started up when the salesperson sings on.

When the salesperson operates the POS terminal 4 to settle the purchased commodities for the customer, the salesperson first uses the scanner 28 to read the bar-code representing her or his own salesperson code. After the scanner 28 reads the bar-code, the CPU 11 carries out query to the file server 2 based on the salesperson code corresponding to the bar-code. The file server 2 receiving the query retrieves the salesperson master file 6 and reads out the salesperson data record 6R including the subject salesperson code. And then, the salesperson data record 6R is sent to the POS terminal 4 at a query end. Therefore, the CPU 11 acquires the salesperson information (the salesperson code, the salesperson name, and the category of authority) from the received salesperson data record 6R. Moreover, the salesperson information is stored in the memory area 41. As thus, the POS terminal 4 is ready to operate, and the control program is started up.

After the control program is started up, the CPU 11 resets the explanation flag F to be 0 (ST1). Subsequently, the CPU 11 judges whether or not the commodity code is input (ST2). If the commodity code is not input (NO of ST2), the CPU 11 waits for the input of the commodity code (ST2).

The salesperson who signs on subsequently operates the scanner 28 to read the bar-code on the commodity purchased by the customer. When the scanner 28 reads the bar-code of the commodity (YES of ST2), the CPU 11 sends the query to the file server 2, using the commodity code corresponding to the bar-code. The file server 2 receiving the query retrieves the commodity master file 5 and reads out the commodity data record 5R including the input commodity code. Then the commodity data record is sent to the POS terminal 4 at the query end. Therefore, the CPU 11 acquires commodity data (the commodity code, the commodity name, the unit price, the explanation differentiation and the like) from the received commodity data record 5R (ST3).

The CPU 11 checks the explanation differentiation in the commodity data (ST4). Herein, If the explanation differentiation is 0, it is indicated that the commodity specified by the input commodity code does not need, the explanation of the salesperson. In this condition (NO of ST4), the CPU 11 enters the process in an act ST12.

Comparatively, if the explanation differentiation is 1, it is indicated that the commodity specified by the input commodity code needs the explanation thereof by the salesperson. In this condition (YES of ST4), the CPU 11 checks the category of authority of the memory area 41 (ST5). Herein, if the category of authority is 0, the salesperson does not have the explanation authority of the commodity. In this condition (NO of ST5), the CPU 11 judges the registration of the commodity whose commodity code is input is in error.

Comparatively, if the category of authority is 1, the salesperson has the explanation authority of the commodity. In this condition (YES of ST5), the CPU 11 displays message of requesting the explanation of the commodity on the display 25 (ST6). And then, the CPU 11 waits for the input of the explanation end key 33 (ST7).

The salesperson who confirms the message on the display 25 explains the usage, the dosage, the side effects and the like of the medicine purchased to the customer. After the explanation is ended, the salesperson operates the explanation end key 33. If the explanation end key 33 is input (YES of ST7), the CPU 11 displays the comprehension degree input screen 8 on the touch panel 26. Then, the CPU 11 waits for the input of any one of the comprehension degrees, i.e., the “fully understand”, the “understand” or the “approximately understand” (ST8: the comprehension degree receiving section).

The customer who receives the explanation of the salesperson about the medicine touches the “fully understand” button 8A if she or he fully understands the explanation, touches the “understand” button 8B if she or he understands the explanation, or touches the “approximately understand” button 8C if she or he approximately understands the explanation. The medicine cannot be sold without understanding the explanation by the customer. Thus, the comprehension degrees in this embodiment do not have other options.

When any one of the buttons 8A, 8B and 8C on the comprehension degree input screen 8 is touched and, in response to the touching, the data representing the comprehension degree is input from the touch panel controller 20 (YES of ST9), the CPU 11 registers the numerical value information corresponding to the comprehension degree, the commodity code and the commodity name in the commodity data acquired in the process of an act ST3 and the salesperson code and the name of the salesperson registered in the memory area 41 in the memory area 43 as one record (ST10: the comprehension degree storing section). On the other hand, the CPU 11 sets the explanation flag to be 1 if the explanation flag F is not set (ST11). Subsequently, the CPU 11 enters the process in an act ST12.

In the act ST12, whether or not any one of the customer layer keys 32 is input is judged (ST12). If the customer layer key 32 is not input (NO of ST12), the CPU 11 waits for the input of a next commodity code (ST2). If the next commodity code is input, the processes after the act ST3 are re-executed.

The salesperson scans the bar-codes of all the commodities purchased by the customer one by one by utilizing the scanner 28. After the bar-codes of all the commodities are read, the salesperson operates one of the customer layer keys 32 according to one of the customer layers recognized from the appearance of the customer. When the customer layer key is input (YES of ST12), the CPU 11 carries out the registration closing process of the commodities purchased by the customer based on the commodity data acquired by the process in the act ST3 (ST13). The registration closing process includes the following processes: displaying the sum amount of the commodities purchased by the customer and the change amount, issuing the receipt on which the details of the commodities purchased by the customer are printed, opening the drawer 29 for keeping cash received or dispensing change, and the like.

After the registration closing process is ended, the CPU 11 checks the explanation flag F (ST14). If the commodities purchased by the customer do not include the commodities explanations of which are required by the salesperson, the explanation flag F is reset to be 0. In this case (NO of ST14), the CPU 11 ends the processes of the control program after the salesperson signs on.

On the other hand, if the commodities purchased by the customer include at least one commodity the explanation of which is required by the salesperson, the explanation flag F is being set to be 1. Moreover, the numerical value information representing the comprehension degree of the customer is being stored in the memory area 43 in association with an identification information (the commodity code, the commodity name) of the commodity which is necessary to be explained and an identification information (the salesperson code, the salesperson name) of the salesperson. In this case (YES of ST14), on each record of the memory area 43, the CPU 11 adds the data of a current date timed by the clock unit 16, and the customer layer code identifying the customer layer corresponding to the customer layer key 32 input-operated in the process of the act ST12 to make an explanation analysis data (ST15), and then, the CPU 11 sends the explanation analysis data to the file server 2 through the communication interface 17 (ST16: a data sending section). In this way, the explanation analysis data sent to the file server 2 is stored in the explanation analysis data file 7. Then, the CPU 11 ends the processes of the control program after the salesperson signs on.

In this way, in the retail store in which the POS system 1 of the embodiment is constructed, if the customer proposes purchase of commodity, the salesperson first reads the own salesperson code by utilizing scanner 28 and signs on to operate the POS terminal 4. Subsequently, the salesperson reads the commodity code of the commodity purchased by the customer by using the same scanner 28 and registers the sales data of the commodity in the POS terminal 4 to which the salesperson signs on.

At this moment, if the registered commodity is the commodity the explanation of which is required by the salesperson, namely the medicine, in the POS terminal 4, it is judged whether or not the salesperson who signs on has the explanation authority for the medicine based on the category of authority that is registered in the memory area 41. If the salesperson has the explanation authority, the message requesting the explanation of the commodity is displayed on the display 25. Therefore, the salesperson explains the usage, the dosage, the side effects and the like of the medicine to the customer. After the explanation is ended, the salesperson operates the explanation end key 33.

As thus, the comprehension degree input screen 8 is displayed on the touch panel 26. Therefore, the customer who receives the explanation of the salesperson touches one of the buttons 8A, 8B and 8C according to own comprehension degree. If the customer touches the “fully understand” button 8A, the numerical value information, i.e., 100 representing the designated comprehension degree is registered in the memory area 43 in association with the identification information of the subject commodity and the identification information of the subject salesperson. Similarly, if the customer touches the “understand” button 8B, the numerical value information, i.e., 80 is registered in the memory area 43 in association with the identification information of the subject commodity and the identification information of the subject salesperson, and if the customer touches “approximately understand” button 8C, the numerical value information, i.e., 60 is registered in the memory area 43 in association with the identification information of the subject commodity and the identification information of the subject salesperson.

After reading the commodity codes of all the commodities purchased by the customer by utilizing the scanner 28, the salesperson imagines gender and age of the customer and operates one of the customer layer keys 32 corresponding to the customer layer imagined. In this way, the customer layer code of the customer layer corresponding to the operated customer layer key 32 and the data of the current date are added to the data registered in the memory area 43 to produce the explanation analysis data. The explanation analysis data is sent to the file server 2 and stored in the explanation analysis data file 7.

That is, corresponding to each sales history of the commodity explanation of which is required by the salesperson, the numerical value information representing the comprehension degree of the customer about the explanation of the salesperson is stored in the explanation analysis data file 7. Therefore, the comprehension degree of the customer about the explanation of the salesperson can be obtained by analyzing the explanation analysis data of the data file 7.

The analysis of the explanation analysis data may be realized in the POS terminal 4 which installs a comprehension degree analysis program. The POS terminal 4 sets a comprehension degree analysis menu in a practical business menu and starts up the comprehension degree analysis program upon selection of the comprehension degree analysis menu. In this way, the selection screen for selecting analysis items is displayed on the display 25. The analysis items include a salesperson, a commodity and a customer layer.

If the analysis item of the salesperson is selected, the CPU 11 of the POS terminal 4 classifies the explanation analysis data recorded in the explanation analysis data file 7 by the salesperson code. Moreover, the number of data of each salesperson code is acquired as the number of explanation times N of the salesperson identified by the salesperson code. Afterwards, the CPU 11 further classifies the explanation analysis data which is classified by the salesperson code in accordance with the comprehension degree information. Subsequently, the number of data of each comprehension degree information is acquired as the number of occurrence times of the comprehension degree, i.e., the “fully understand”, the “understand” or the “approximately understand”, specified by the comprehension degree information. In addition, a value 100I obtained by multiplying the number of occurrence times I of the comprehension degree “fully understand” by the numerical value 100, a value 80J obtained by multiplying the number of occurrence times J of the comprehension degree “understand” by the numerical value 80 and a value 60K obtained by multiplying the number of occurrence times K of the comprehension degree “approximately understand” by the numerical value 60 are summed, and then are divided by the number of explanation times N of the salesperson to work out a value as an average comprehension degree X [referring to the following formula (1)].

X=(100I+80J+60K)/N (1)

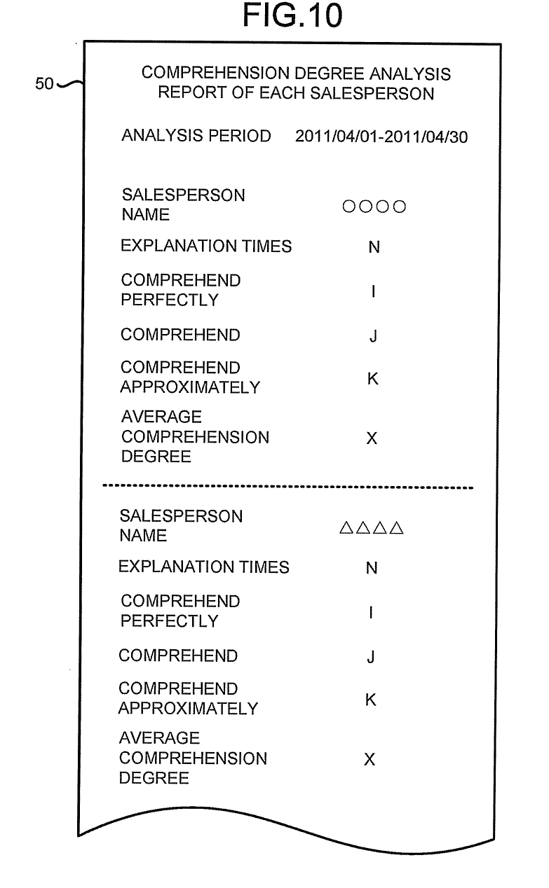

In this way, after the average comprehension degree X of each salesperson is worked out, the CPU 11 classifies the number of explanation times N of each salesperson, the number of occurrence times I, J and K of each comprehension degree and the average comprehension degree X according to the descending order or the ascending order of the average comprehension degree X, and the results are printed out on a receipt paper by the printer 27 with a layout shown in FIG. 10 to issue a comprehension degree analysis report for each salesperson 50 (a comprehension degree analysis section).

If the analysis item for each commodity is selected, the CPU 11 of the POS terminal 4 classifies the explanation analysis data recorded in the explanation analysis data file 7 according to the commodity code. Afterwards, the number of data of each commodity code is acquired as the number of explanation times N of the commodity identified by the commodity code. Subsequently, the CPU 11 further classifies the explanation analysis data which is classified according to the commodity code in accordance with each comprehension degree information. Next, the number of data of each comprehension degree information is acquired as the number of occurrence times of the comprehension degree, i.e., the “fully understand”, the “understand” or the “approximately understand” specified by the comprehension degree information. In addition, the value 100I obtained by multiplying the number of occurrence times I of the comprehension degree “fully understand” by the numerical value 100, the value 80J obtained by multiplying the number of occurrence times J of the comprehension degree “understand” by the numerical value 80 and the value 60K obtained by multiplying the number of occurrence times K of the comprehension degree “approximately understand” by the numerical value 60 are summed, and then are divided by the number of explanation times N of the commodity to work out the value as the average comprehension degree X [referring to the formula (1)].

In this way, after the average comprehension degree X is worked out according to each commodity, the CPU 11 classifies the number of explanation times N of each commodity, the number of occurrence times I, J and K of each comprehension degree and the average comprehension degree X according to the descending order or the ascending order of the average comprehension degree X, and the results are printed out on the receipt paper by the printer 27 to issue a comprehension degree analysis report for each commodity (the comprehension extent analysis section).

If the analysis item of the customer layer is selected, the CPU 11 of the POS terminal 4 classifies the explanation analysis data recorded in the explanation analysis data file 7 according to the customer layer code. Afterwards, the number of data of each customer layer code is acquired as the number of explanation times N for the customer of the customer layer identified by the customer layer code. Subsequently, the CPU 11 further classifies the explanation analysis data which is classified according to the customer layer code in accordance with the comprehension degree information. Afterwards, the number of data of the comprehension degree information is acquired as the number of occurrence times of the comprehension degree, i.e., “fully understand”, the “understand” or the “approximately understand”, specified by the comprehension degree information. In addition, the value 100I obtained by multiplying the number of occurrence times I of the comprehension degree “fully understand” by the numerical value 100, the value 80J obtained by multiplying the number of occurrence times J of the comprehension degree “understand” by the numerical value 80 and the value 60K obtained by multiplying the number of occurrence times K of the comprehension degree “approximately understand” by the numerical value 60 are summed, and then are divided by the number of explanation times N for the customer of the customer layer to work out the value as the average comprehension degree X [referring to the formula (1)].

In this way, after the average comprehension degree X is worked out according to the customer layer, the CPU 11 classifies the number of explanation times N for the customers of each customer layer, the number of occurrence times I, J and K of each comprehension degree and the average comprehension degree X according to the descending order or the ascending order of the average comprehension degree X, and the results are printed out on the receipt paper by the printer 27 to issue a comprehension degree analysis report for each customer layer (the comprehension degree analysis section).

According to the comprehension degree analysis report for each salesperson 50, the explanation capability of each salesperson can be evaluated. That is, salespersons with a high average comprehension degree X may be evaluated to have a superior explanation capability, and, on the other hand, salespersons with a low average comprehension degree X may be evaluated to have an insufficient explanation capability.

According to the comprehension degree analysis report for each commodity, the difficulty in understanding of explanation content of each commodity can be evaluated. That is, explanation contents of the commodity with the high average comprehension degree X may be evaluated to be concise, and explanation contents of the commodity with the low average comprehension degree X may be evaluated to be difficult to understand.

According to the comprehension degree analysis report for each customer layer, the comprehension capability of the customer layers may be evaluated. That is, customers of the customer layer with the high average comprehension degree X may be evaluated to have a high comprehension capability, and customers of the customer layer with the low average comprehension degree X may be evaluated to have a low comprehension capability. Therefore, for the customers of the customer layer with the low average comprehension extent X, explanation is carried out more thorough than the customers of the customer layer with the high average comprehension degree X, thereby being capable of improving the customer's satisfaction.

Hereinafter, other embodiments are described.

In the embodiment described above, the comprehension degrees are divided into three stages, i.e., “fully understand”, “understand” and “approximately understand”, but the comprehension degrees are not limited to the three stages. The comprehension degrees may be simply divided into two stages or also may be subdivided into more than four stages. Otherwise, the comprehension degree can be converted into the numerical value by customers and then is input by themselves.

Moreover, in the above-described embodiment, the comprehension degree input screen 8 is displayed on the touch panel 26 upon an input of the explanation end key 33 as a premise, but the timing of displaying the comprehension degree input screen 8 is not limited to that. The comprehension degree input screen 8 also may be displayed before the beginning of the explanation to enter the process of the act ST10 upon the reception of the input of the explanation end key 33 and the input of the selected comprehension degree as a premise.

Moreover, in order to keep the fact that the salesperson performs explanation of the commodity to the customer as a record, the apparatus further may be provided with a button which is operated by the customer after the customer receives the explanation. When the customer operates the operation button, the apparatus stores information such as the identification information of the subject commodity, the identification information of the salesperson, operation date and time, a transaction serial number and the like.

Moreover, in the embodiment, the medicines are taken as an example for the commodities the explanation of which is required by the salesperson, but the commodities whose explanation is required by the salesperson are not limited to the medicines. For example, the explanation of the salesperson is also needed when hazardous articles such as agricultural chemicals and tools are sold, and the embodiment also may be directly applied in these cases.

In addition, in the embodiment, the control program for realizing an inventive function is previously stored in the ROM 13 in the apparatus. However, the control program is not limited to that, and the same program also may be downloaded in the apparatus from the networks. Peradventure, the same program stored in storing medium also may be installed on the apparatus. So long as the storing medium is a CD-ROM, a storing card and the like, which are capable of storing the program and may be read by the apparatus, the form of the storing medium is not limited. Moreover, the function acquired by the installation or the downloading of the program also may be realized by the synergic action with an OS (operating system) and the like in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity sales data processing apparatus, comprising:
a comprehension degree receiving section configured to receive input of a comprehension degree which represents degree of comprehension of a customer purchasing a commodity against an explanation of the commodity by a salesperson if the sales data of the commodity whose explanation is required by the salesperson is input; and
a comprehension degree memory section configured to store an information indicating the comprehension degree received through the comprehension degree receiving section in association with an identification information of at least one of the commodity and the salesperson.

2. The apparatus according to claim 1, further comprising:
a data transmitting section configured to transmit a relation data indicating that the information indicating the comprehension degree stored in the comprehension degree memory section is associated with the identification information, to a server which stores the relation data.

3. The apparatus according to claim 2, further comprising:
a comprehension degree analysis section configured to analyze the comprehension degree of the customer based on the relation data stored in the server.

4. The apparatus according to claim 3, wherein
the comprehension degree analysis section analyzes the comprehension degree of the customer for each salesperson or commodity.

5. The apparatus according to claim 1, further comprising:
a declaration section configured to declare that the explanation of the salesperson about the commodity is ended, wherein the comprehension degree receiving section receives the input of the comprehension degree upon declaration of ending the explanation by the declaration section.

6. A control method of a commodity sales data processing apparatus, comprising:
receiving input of a comprehension degree which indicates degree of the comprehension of a customer purchasing a commodity against the explanation of the commodity by a salesperson if the sales data of the commodity whose explanation is required by the salesperson is input; and
storing an information indicating the comprehension degree received in association with an identification information of at least one of the commodity and the salesperson.
